(19) United States
(12) Patent Application Publication
(10) Pub. No.: US 2019/0335765 A1
(43) Pub. Date: Nov. 7, 2019

(54) Mixture, Paste-Like Composition and Method for Producing Soft Wheat Flour Pasta

(71) Applicant: PANZANI, Lyon (FR)

(72) Inventors: Isabelle Francoise AREKION, Marseille (FR); Alain Auguste Alphonse POURTHIER, Allauch (FR)

(21) Appl. No.: 16/340,250

(22) PCT Filed: Oct. 12, 2017
(86) PCT No.: PCT/FR2017/052817

§ 371 Date: Apr. 8, 2019

(30) Foreign Application Priority Data
Oct. 13, 2016 (FR) 1659935

(51) Int. Cl. A21D 10/00; A21D 2/06; A21D 2/16; A21D 2/28; A23L 7/109; A23L 7/10

(52) U.S. Cl. CPC A21D 10/005; A21D 2/06; A23L 7/198; A21D 2/28; A23L 7/109; A21D 2/16

(57) ABSTRACT

The invention relates to a mixture intended to be hydrated to form a paste-like composition comprising gluten, for producing pasta, said mixture including a wheat flour composed substantially exclusively of soft wheat flour, a reducing agent and an amylose complexing agent and said flour being the only source of gluten in said paste-like composition. The invention also relates to a gluten-containing paste-like composition, intended to be shaped and dried to form pasta and comprising the above type of mixture and water to hydrate said mixture. The invention further relates to pasta prepared by shaping and drying a paste-like composition of this type, and to a method for production of the same.

### TECHNICAL FIELD

The present invention relates to the general field of pasta and methods for making same, and in particular the field of mixtures based on wheat flour and paste-like compositions comprising gluten implemented for making pasta.

The invention more particularly relates to a mixture intended to be hydrated to form a paste-like composition comprising gluten, for making alimentary pastes, said mixture including a wheat flour substantially exclusively composed of soft wheat flour.

The invention also relates to a paste-like composition comprising gluten intended to be shaped and dried to form alimentary pastes.

The invention further relates to an alimentary paste prepared by shaping and drying such a paste-like composition.

The invention finally relates to a method for making alimentary pastes comprising a step of preparing a paste-like composition comprising gluten, by hydrating a mixture as introduced hereinabove.

### PRIOR ART

If alimentary pastes (or pasta), and more especially dry pasta, are generally made from durum wheat (Triticum durum) flour or semolina, it is known to replace all or part of this durum wheat flour by another flour, for example soft wheat (Triticum aestivum) flour.

Indeed, the latter, commonly used in bakery and pastry, is often more available than durum wheat flour.

However, the soft wheat flour has not the same characteristics as the durum wheat semolina. In particular, its gluten content, and hence protein content, is lower than that of the durum wheat flour. Moreover, it is considered that the structure itself and the gluten quality of the soft wheat are different from those of the durum wheat gluten.

Anyway, it is generally observed that the soft wheat pasta is often of lesser quality. In particular, the soft wheat flour pasta indeed generally turns out to be softer and less elastic after cooking in boiling water than the pasta obtained from a flour composed exclusively of durum wheat floor. They further have a lesser firmness to cooking and become very deliquescent and sticky in case of over-cooking.

In order to make up for these drawbacks, it has been proposed to mix enzymes, for example of the lipase type, to the soft wheat flour during the preparation of the pasta paste-like composition. If such a paste-like composition is wholly satisfying, it nevertheless suffer from certain drawbacks. Indeed, apart from the fact that the so-obtained results remain perfectible, such enzymatic additives often prove to be relatively expensive and complex to implement in an industrial context. Moreover, the implementation of enzymes to correct the defects of a paste-like composition made of soft wheat flour tends to impact the colour of the so-obtained pasta, which then sometimes generates the need to add additional additives, such as colouring agents. Moreover, the pasta obtained by means of such enzymatic additives is sometimes considered as too brittle after cooking.

### DISCLOSURE OF THE INVENTION

The objects assigned to the invention hence aim to remedy the various drawbacks exposed hereinabove and to propose a new mixture based on wheat flour substantially exclusively composed of soft wheat flour, and a new associated paste-like composition, for easily obtaining alimentary pastes having a quality after cooking that is very closed to that of the alimentary pastes usually made based on durum wheat flour, while limiting the use of corrective agents.

Another object of the invention aims to propose new dry soft wheat alimentary pastes, easy to make, while offering before cooking a perfect visual aspect and, after cooking by immersion into boiling water, organoleptic characteristics very close to those of the alimentary pastes usually made from durum wheat flour, while limiting the use of corrective agents.

Another object of the invention aims to propose a new method for making soft wheat pasta from a paste-like composition comprising gluten, which is particularly easy to implement and requires no specific equipment.

The objects assigned to the invention are reached by means of a mixture intended to be hydrated to form a paste-like composition comprising gluten, for making alimentary pastes, said mixture including a wheat flour substantially exclusively composed of soft wheat flour, characterized in that it includes a reducing agent and an amylose-complexing agent and in that said wheat flour is the only source of gluten of said paste-like composition.

The objects assigned to the invention are also reached by means of a paste-like composition comprising gluten, intended to be shaped and dried to form alimentary pastes, characterized in that it comprises a mixture according to the foregoing and water to hydrate said mixture.

The objects assigned to the invention are further reached by means of an alimentary paste prepared by shaping and drying a paste-like composition according to the foregoing.

The objects assigned to the invention are further reached by means of a method for making alimentary pastes comprising a step of preparing a paste-like composition comprising gluten, by hydrating a mixture according to the foregoing.

Other objects and advantages of the invention will be better understood from the following description.

### BEST WAY TO IMPLEMENT THE INVENTION

According to a first aspect, the invention relates to a mixture intended to be hydrated, i.e. be humidified by an aqueous solution, to form a paste-like composition comprising gluten, for making alimentary pastes. In the sense of the invention, herein and hereinafter, it is preferably understood by “alimentary paste(s)” an edible product entering in the human (or even animal) food made at least based on a kneaded mixture of flour and water, which may affect very various shapes, as for example a shape of blade (such as, for example, lasagna), ribbon (such as, for example, noodles or tagliatelle), cords (such as, for example, vermicelli, spaghetti, capellini), hollow tube (such as, for example, macaroni, pasta shells), cushion (such as, for example, ravioli), or another shape (such as, for example, farfalle, fiori, fusilli, rotelle, etc.). Advantageously, the term “alimentary paste(s)” more specifically cross-refers to a cereal speciality, said flour being obtained from at least one cereal, herein wheat. In any case, the term “alimentary paste(s)” should not, in the context of the invention, be interpreted from a strictly regulatory point of view, as can be the case in certain countries.

The alimentary pastes in question are, preferably, obtained by kneading without fermentation, shaping then drying of said paste-like composition. These alimentary pastes are hence, in the sense of the invention but non-limitatively, dry pasta. Preferably, the alimentary pastes to which the invention relates are intended to be cooked by being fully immersed into a great quantity of boiled water, a cooking mode that allows them to develop, through suitable chemical reactions and their specific composition also adapted to this cooking mode, their intrinsic organoleptic characteristics as well as a particular texture.

In the sense of the invention, it is further preferentially understood by “paste-like composition” an intermediate humid composition, having a consistency that is neither fully solid nor fully liquid, but on the contrary soft, flexible, intended to be shaped (for example, by means of a mould or a die) to form humid (or “fresh”) alimentary pastes, then advantageously dried to form dry pasta ready to be cooked by immersion into boiling water.

This mixture includes, as a main ingredient, a wheat flour substantially exclusively composed of soft wheat flour (Triticum aestivum L. subsp. Aestivum or wheat for breadmaking flour), and hence does not contain, to within the potential traces of contamination, durum wheat flour (Triticum turgidum L. subsp. durum). For convenience reasons, the terms “flour” or “semolina” will be used indifferently herein to refer in particular to a durum wheat grinding. It is however still contemplatable, without departing from the framework of the invention, that said mixture includes, in addition to said wheat flour, another cereal and/or fodder flour.

Particularly interestingly, the average particle size of this soft wheat flour will be preferentially strictly lower than about 200 μm, still preferably substantially comprised between 40 and 150 μm, and still more advantageously of about 100 μm on average. Its size dispersion will advantageously be comprised between about 40 and 50 μm. Such a selection will hence advantageously allow obtaining a better penetration of the mixture by the aqueous liquid during the hydration of said mixture, while optimizing the kneading time required to obtain an excellent homogeneity of the so-obtained paste-like composition. Preferably, said wheat flour will have a protein content in dry matter comprised between about 8 and 11%, preferably lower than 10%, for example equal to 9.9%, these proteins preferably coming substantially predominantly from gluten (gliadin, glutenin) of the wheat flour in question (for example, of the order of at least 70% to 80%). Moreover, said wheat flour will preferably be chosen with a relatively high ash content, for example a content comprised between about 0.4 and 0.7%, expressed on dry matter basis, preferably comprised between 0.5 and 0.6%.

During comparative tests, performed by the applicant, of making and cooking durum wheat alimentary pastes, on the one hand, and soft wheat alimentary pastes, on the other hand, it has been confirmed that the alimentary pastes obtained from a mixture comprising a wheat flour substantially exclusively composed of soft wheat flour show, in the absence of any improving or correcting agent, serious texture defects with respect to alimentary pastes obtained from a wheat flour substantially exclusively composed of durum wheat flour. The observed defects in question have appeared during the cooking of the alimentary pastes in the boiling water, when the paste-like composition is hydrated and when the starch it contains is gelatinized to make it digestible. The following explanation of the phenomenon may be proposed. The durum wheat proteins are in particular composed of gliadin γ-45, which can be considered as taking part in the formation of an extensible gluten network. From then on, the gluten network that is formed in the paste-like composition during the extrusion thereof and that is cross-linked during the drying step that usually follows the step of shaping the paste-like composition, is adapted to contain the swelling of the starch grain that accompanies the gelatinization of the latter during the cooking. More precisely, the uncrosslinked linear amylose chains, which compose the starch, seem to remain caught in the gluten network. The alimentary pastes so obtained from only exclusively durum wheat flour will hence a priori tend to remain firm and elastic and non-sticky, even in case of over-cooking. On the contrary, the soft wheat seems to have a tenacious and less extensible gluten network. This property of the soft wheat gluten may be explained by the presence of very-reticulated high-molecular-weight glutenins with many covalent, intra and intermolecular disulfide links. The hydration of the mixture containing the wheat flour to form a paste-like composition, and the compression and shaping of the latter by extrusion during the making of alimentary pastes seem to provide the glutenins with a great mobility allowing them to interact with each other and to increase the size of the aggregates and the number of interactions between the proteins, which would tend to make the network more tenacious, i.e. more resistant to extension. At the moment of cooking such soft wheat alimentary pastes, this low-stretch gluten network is highly liable to break under the pressure due to the swelling of the starch grains. The alimentary pastes will soften and the small linear amylose chains will be able to escape therefrom and diffuse into the cooking water, so that the alimentary pastes will become sticky and surface deliquescent. To compensate for this highly undesirable behaviour during cooking, the mixture of the invention includes, in addition to said wheat flour, two particular correcting agents to act, on the one hand, on the gluten of the soft wheat, and on the other hand, on the starch of the latter. Such a strategy tends to go against the current practices in the field of alimentary paste making, according to which the emphasize is usually put on improving the characteristics of the gluten and the protein network.

According to the invention, said mixture hence first includes a first correcting agent that is a reducing agent, advantageously adapted to modify the properties of the soft wheat gluten. Preferably, said mixture includes from about 0.005 to 1% in weight of such a reducing agent relative to the total weight of the mixture, this content being expressed on dry matter basis. Advantageously, this reducing agent is a sulfhydryl-containing reducing agent specifically chosen for its capacity to act on the high-molecular-weight glutenins by targeting their thiols (—SH) and disulfide (S—S) groups. This reducing agent will, in particular, reduce the disulfide links that structure the glutenins and hence provide extensibility to the gluten network. Such a sulfhydryl-containing reducing agent will be advantageously chosen among the group formed by the sulphur dioxide, the sodium metabisulphite, the L-cysteine and its hydrochlorides (sodium and potassium salts), and the glutathione. We will preferably retain especially L-cysteine and the derivatives thereof (hereinafter denoted by the single term “L-cysteine” for reasons of simplicity), it being a widespread amino acid whose effects are relatively well known and controlled.

The mixture of the invention also includes a second correcting agent that is an amylose-complexing agent, in a content expressed on a dry matter basis, which is preferentially comprised between about 0.5 and 1% in weight of amylose-complexing agent relative to the total weight of the mixture. By forming a complex with the molecules of amylose of the soft wheat flour starch, this second correcting agent will de facto make these amylose molecules insoluble. In synergy of action with the above-described reducing agent, this amylose-complexing agent will hence advantageously allow highly limiting, or even preventing, the washing of the amylose molecules and their diffusion out of the alimentary pastes during the cooking in boiling water. Advantageously, the amylose-complexing agent is an emulsifier advantageously chosen among the group formed by the fatty acid monoglycerides and diglycerides and the esters of these latter. Indeed, the amylose molecules are liable to affect an helical structure whose inside is provided with lipophilic C—H groups. Monoacyl lipids of small diameter may hence penetrate such an helical structure and link to the latter to form a stable and insoluble complex. Preferably, said amylose-complexing agent is a water-soluble or at least water-dispersible emulsifier. Indeed, it has been observed that such emulsifiers are more homogeneously distributed in the paste-like composition, during the hydration of the mixture, as close as possible to the particles of wheat flour and to the amylose molecules thereof. As such, it will hence be possible to advantageously select an amylose-complexing agent consisted of water-soluble or at least water-dispersible monoglycerides. In the particularly preferential case in which the reducing agent is the L-cysteine and the amylose-complexing agent is consisted of water-soluble or at least water-dispersible monoglycerides, an optimum in terms of correcting effects seems to be reached when the mixture advantageously includes from 0.03 to 0.1% in dry matter, and preferably 0.06%, of L-cysteine, and from 0.5 to 1% in dry matter, and preferably 0.88%, of monoglycerides.

It will be noted that, in the case where said amylose-complexing agent is on the contrary a liposoluble emulsifier (for example consisted of monoglycerides), but not soluble or dispersible in water, it will be contemplatable to previously solubilize the latter in a liquid fat body, for example in sunflower, colza or also olive oil. By way of example, it will then for example be possible to form a mixture from 98.85% of soft wheat flour, 0.6% of monoglycerides, 0.05% of L-cysteine and 0.5% of sunflower oil.

On the other hand, these reducing and amylose-complexing agents are preferably the only correcting agents added to the wheat flour. In particular, said wheat flour is, according to the invention, the only source of gluten of said paste-like composition. In other words, the mixture of the invention, like the paste-like composition that results therefrom after hydration, contains no additional source of gluten, for example vital gluten. Moreover, said mixture is advantageously devoid of any additional enzymatic agent (lipases, etc.). Also, said mixture, like said paste-like composition obtained after hydration, comprises preferentially no additional low temperature coagulable proteins, such as proteins coming from eggs or other. Preferably, the wheat flour is the only source of proteins of said mixture.

The applicant has indeed observed, in a very interesting and unexpected manner, during the iterative test campaigns it has carried out, that such a mixture would allow obtaining, after hydration of the latter to form a paste-like composition, alimentary pastes made of wheat flour substantially exclusively composed of soft wheat flour having an organoleptic quality after cooking that is very close to that usually observed for alimentary pastes exclusively made of durum wheat flour.

The invention also relates, as such, a paste-like composition comprising gluten intended to be shaped and dried to form alimentary pastes, as well as an alimentary paste prepared by shaping and drying of such a paste-like composition. This paste-like composition comprises a mixture according to the above description and water to hydrate said mixture, wherein said mixture and water are advantageously homogeneously distributed in said paste-like composition. The paste-like composition of the invention is hence formed by hydration of said mixture, preferentially by incorporation of an aqueous liquid to said mixture, this aqueous liquid being preferably exclusively composed of drinkable water. Said paste-like composition has advantageously a humidity rate comprised between about 31 and 32.5%, or even between 32 and 32.5%, according to the properties of the wheat flour used and to the technical means implemented. As for the alimentary paste according to the invention, it is preferentially neither cooked nor stuffed, not prepared in another way. It has preferably, once finished and ready to be packed and marketed, a residual humidity rate comprised between 11 and 13%, preferably comprised between 12 and 12.5%.

The invention also relates, as such, to a method for making alimentary pastes, advantageously designed to allow the making of dry alimentary pastes as introduced hereinabove. Preferably, this method is adapted to an industrial or semi-industrial environment, in particular in terms of typology of technical means implemented, cadence and volume considered, and is provided so that it can be implemented by any means also known in the field of making industrial or semi-industrial alimentary pastes.

The method of the invention comprises at least one step of preparing a paste-like composition comprising gluten, by hydration of a mixture according to the above description. As mentioned hereinabove, this mixture hydration during said elaboration step is preferentially carried out by progressively incorporating (for example by spraying) an aqueous liquid to said mixture, which aqueous liquid is preferably exclusively composed of drinkable water. The use of a tepid or even warm aqueous liquid may allow a faster and more homogeneous diffusion of the latter within said mixture, while reducing the duration of the preparation step. However, the temperature of this aqueous liquid will preferably remain comprised between 25 and 45° C., so as not to degrade at this step the components of the wheat flour (and in particular its proteins). Said mixture is hence hydrated until the humidity rate of said paste-like composition is preferentially comprised between about 31 and 32.5%, or even between 32 and 32.5% according to the properties of the wheat flour used and the technical means implemented. Once said mixture hydrated to form said paste-like composition, the latter is kneaded without fermentation, for example in a conventional mixer, so as to provide a perfectly homogeneous hydration of the paste-like composition and an optimum distribution of the reducing agent and the amylose-complexing agent within the latter. For the reasons explained hereinabove, the temperature of the paste-like composition during this kneading step will be advantageously maintained lower than 45° C. The duration of the kneading step is preferably comprised between 10 and 30 minutes, but it will possibly be elongated to provide a homogeneous hydration of all the particles of wheat flour and the correcting agents added. Preferably, this kneading step is carried out under ambient atmospheric pressure.

Preferably, said method comprises, previously to the step of preparing said paste-like composition, a step of preparing said mixture during which a homogeneous mixture is formed from a wheat flour substantially exclusively composed of soft wheat flour, a reducing agent and an amylose-complexing agent, these wheat flour and reducing and complexing agents being according to the foregoing. During this step, said reducing and amylose-complexing agents will be preferably incorporated into the wheat flour in powder form, said so-formed mixture being hence in the form of an advantageously powdery mixture. Of course, it is however not excluded herein that either one of said agents can be in liquid form. In order to facilitate the implementation, and in particular the weighing, of the reducing agent and/or the amylose-complexing agent, these latter can be one and/or the other be previously pre-mixed with wheat flour or soft wheat starch. The wheat flour implemented will preferably have a humidity rate comprised between 11 and 14%, preferably substantially close to 12.5%. Hence, the correcting agents, i.e. the reducing agent and the amylose-complexing agent, are hence advantageously intimately mixed with the wheat flour to form a mixture according to the invention before introduction of the hydration aqueous liquid. As an alternative, it could be contemplated that the step of preparing the paste-like composition is on the contrary preceded by a step of preparing an aqueous solution formed of a mixture of water and of said correcting agents, which aqueous solution is then progressively incorporated to the soft wheat flour to hydrate it and finally form said paste-like composition. However, controlling the final humidity rate of said paste-like composition may in this case turn out to be more complex and less fine.

The method of the invention is then advantageously continued with a step of vacuuming, for example to a residual pressure comprised between about 0.1 bar and about 0.25 bar, the paste-like composition previously obtained so as to deaerate the latter and to so avoid the formation of bubbles particularly harmful during the shaping of the paste-like composition according to the invention. The method then preferably comprises a step of compressing said paste-like composition. During this step, the paste-like composition is subjected to a mechanical compression in order to favour the formation of the gluten network it contains. Preferentially, this mechanical compression is carried out, for example with an extrusion screw, under a pressure comprised between about 70 and 110 bars, preferably equal to about 100 bars. As such a compression of the paste-like composition tends to warm the latter, a means for cooling the extrusion screw will be provided to cause the paste-like composition temperature to remain advantageously lower than 45° C.

Then, the compressed paste-like composition obtained after the vacuuming and compression step is preferably subjected to a shaping step to obtain alimentary pastes, which are at this step humid and raw, i.e. “fresh”, of predefined shapes, using dies, moulds or stamping machines, for example. This step is preferably followed with a drying step to form, from said shaped paste-like composition, dry alimentary pastes that have advantageously a residual humidity rate comprised between 11 and 13%, preferably comprised between 12 and 12.5%.

Advantageously implemented in a conventional industrial paste drier, such as a drier usually used to dry alimentary pastes exclusively made of durum wheat flour, this drying step is carried out with hot and humid air by following, as already known as regards the making of durum wheat pasta, a precise scheme with several steps and with a specific control at each step, taking into account the temperature and hygrometry of the drying air. As well known by the one skilled in the art, each type or shape of alimentary pastes requires a specific drying scheme that takes into account its shape and thickness. That being, whatever the type or shape of the alimentary pastes desired to be made, the method of the invention preferably comprises a pre-drying phase at the end of which the humidity rate of said pastes is of about 18%, followed with at least one drying phase at the end of which the relative humidity of said alimentary pastes is comprised between about 11 and 13%, preferably between about 12 and 12.5%. Preferably, as will be detailed hereinafter, the conditions of temperature and hygrometry of air applied during these pre-drying then drying phases are different.

Having a relatively short duration with respect to that of the drying phase, for example of the order of 30-45 min, the pre-drying phase aims to rapidly evacuate a great part of the water contained in the shaped paste-like composition (typically of the order of 40-45%). The water desorption of a paste-like composition formed from a mixture exclusively made of soft wheat flour however turns out to be faster than that usually observed with a durum wheat flour. In order to control the speed of desorption and to hence avoid any phenomenon of fissuring and cracking of the dry alimentary paste obtained, the climate of air used during this pre-drying phase will be advantageously adjusted by maintaining a relatively high relative humidity rate of air with respect to what is usually used for the durum wheat alimentary pastes.

More precisely, in the case of “shorn” alimentary pastes (such as pasta shells, farfalle, fusilli, etc.), said pre-drying phase can be advantageously carried out under a first temperature of air maintained constant and comprised between about 70 and 90° C., preferably close to 80° C., and under a first relative humidity rate of air progressively decreased from about 90% to about 80%, preferably from about 85% to about 80-81%. The average speed of desorption during the pre-drying step can hence, for example, be close to −0.4% humidity par minute, and said first relative humidity rate of air can be maintained, for example, about 3% to 5% higher than that usually implemented for durum wheat alimentary pastes.

In the case of “long” alimentary pastes (such as spaghetti, capellini, spaghettone, etc.), said pre-drying phase can advantageously be carried out under a first temperature that is progressively increased from 50° C. to 75-80° C., i.e. the pre-drying phase is initiated at a temperature of 50° C., then continued whereas the temperature is progressively increased up to 75-80° C., and under a first humidity rate comprised between about 70 and 80%.

Moreover, it is also advantageously possible to increase the duration of this pre-drying phase with respect to the corresponding duration usually implemented for the durum wheat alimentary pastes, so as to more finely control the speed of water desorption and hence to avoid at most any cracking phenomenon.

At the end of this pre-drying phase, the average humidity rate of the paste-like composition is hence advantageously decreased down to 18%, but there however still exists a high gradient of residual humidity between the surface and the core of the alimentary pastes, the surface being herein drier than the core. The drying phase is then advantageously carried out by applying specific conditions to reduce the gradient of humidity between the surface and the core of the alimentary paste while reinforcing the protein network created during the compression step.

More precisely, in the case of “short” alimentary pastes, said drying phase can advantageously be carried out under a second temperature of air maintained constant and comprised between about 70 and 90° C., while being lower than said first temperature (for example between 70 and 78-80° C.) and under a second relative humidity rate of air progressively decreased from about 80% to about 75%, preferably from about 80-81% to about 78%.

In the case of “long” alimentary pastes, said drying phase can advantageously be carried out under a second temperature of air maintained constant and comprised between about 75° C. and 90° C., preferably higher than 80° C., while being higher than the maximum temperature reached during the pre-drying phase, and under a second relative humidity rate of air comprised between about 70 and 75%.

So carried out at high temperature and hygrometry, this drying phase not only allows stabilizing the humidity of the alimentary pastes obtained but also causing changes in the gluten network by denaturing the proteins, with a beneficial effect on the texture and the stickiness of the alimentary pastes at the time of the final cooking in boiling water. Having a preferential duration of the order of about 250 min, said drying step can possibly be extended to optimize this effect. At the end of this drying phase, the humidity rate of the dry alimentary pastes obtained from the paste-like composition is hence advantageously decreased down to between about 11 and 13%, preferably between about 12 and 12.5%, so as to guarantee the good preservation.

It results from what precedes that said pre-drying and drying phases are hence advantageously carried out at high temperature (between 70 and 90° C.), as practised industrially in the case of durum wheat pasta, and not at very high temperature (i.e. for example between 95° C. and 105° C.), contrary to what is sometimes recommended, in particular by the industrial drier manufacturers, for making soft wheat pasta.

Finally, said drying step advantageously further comprises, at the end of this drying phase, a cooling phase during which the temperature of air is brought back to a temperature close to the ambient temperature (typically of the order of 20-25° C.). This cooling phase is preferentially carried out by abruptly decreasing the temperature and relative humidity of air, i.e. very rapidly with respect to the duration of the preceding pre-drying and drying phases, the relative humidity of air being however decreased less rapidly than the temperature of air, in order to preserve the integrity of the dry alimentary pastes obtained. By way of example, the temperature of air can then be averagely decreased by about 1° C. per minute. Moreover, the relative humidity rate of air can be decreased by about 0.3% per minute, it being understood that the most influent parameter to be preferentially adjusted is the temperature of air.

The method according to the invention hence has for major interest to allow obtaining, from a mixture formed of a wheat flour substantially exclusively composed of soft wheat flour, a reducing agent and an amylose-complexing agent, alimentary pastes having, after cooking, a quality very close to that of the alimentary pastes conventionally obtained from only durum wheat, and that without even so requiring the implementation of specific and complex equipment devices.

Comparative tests of making conventional dry durum wheat alimentary pastes and dry soft wheat alimentary pastes from the mixtures and composition of the invention, and with a method according to the invention, have been carried out by the applicant in order to confirm and measure the improvement provided by the mixture, the paste-like composition and the method of the invention.

### 1^{st} Series of Tests and Analyses

In a first time, a first homogeneous mixture has been prepared from 98.85% of soft wheat flour (at 13.60% humidity, 0.52% ashes and 10.10% proteins in dry matters), 0.6% of non-water-soluble monoglycrides, 0.05% of L-cysteine and 0.5% of sunflower oil, i.e. 3000 g of soft wheat flour, 20 g of non-water-soluble monoglycerides, 15 g of sunflower oil and 1.5 g of L-cysteine. This mixture has been hydrated by water until forming a paste-like composition having a humidity rate of about 32-32.5%, which paste-like composition has been extruded and shaped by being passed through a mould to form alimentary pastes of the spaghetti type of diameter 1.55 mm. After drying, the so-obtained soft wheat alimentary pastes have been compared before and after cooking, with, on the one hand, conventional spaghetti-format alimentary pastes made of durum wheat (100% durum wheat flour) and, on the other hand, spaghetti-format alimentary pastes made of soft wheat flour (100% soft wheat flour), without correcting agents.

The results of this first series of test are summarized in the following tables.

| | Format | | |
|---|---|---|---|
| | Spaghetti | Spaghetti | Spaghetti |
| | Ingredients | | |
| | 100% durum | | 98.85% soft wheat flour + |
| | wheat flour | | 0.6% monoglycerides + |
| | (reference | 100% soft | 0.05% L-cysteine + |
| | standard) | wheat flour | 0.5% sunflower oil |
| Averaqe L* | 58.04 | 59.94 | 58.23 |
| Averaqe a* | 11.36 | 8.06 | 11 |
| Averaqe b* | 46.5 | 38.62 | 40.94 |

Comparative analysis of the colour of the raw alimentary pastes obtained, by determining colorimetric indices L, a, b (CIE system).

| | Format | | |
|---|---|---|---|
| | Spaghetti | Spaghetti | Spaghetti |
| | Ingredients | | |
| | 100% durum | | 98.85% soft wheat flour + |
| | wheat flour | | 0.6% monoglycerides + |
| | (reference | 100% soft | 0.05% L-cysteine + |
| | standard) | wheat flour | 0.5% sunflower oil |
| Firmness at T | 60.39 | 39.98 | 60.89 |
| Firmness at 1.5 | 52.94 | 27.19 | 52.91 |
| T (over-cook- | | | |
| ing) | | | |
| Viscoelasticity | 18.22 | 6.53 | 17.92 |
| at T | | | |
| Viscoelasticity | 14.37 | 2.79 | 13.72 |
| at 1.5 T | | | |
| (over-cooking) | | | |

Comparative analysis of the mechanical characteristics of the alimentary pastes obtained after cooking during T=9 min in 1 L of water with 7 g of salt, by means of a texturometer TA.XT-plus.

| | Format | | |
|---|---|---|---|
| | Spaghetti | Spaghetti | Spaghetti |
| | Ingredients | | |
| | 100% durum | | 98.85% soft wheat flour + |
| | wheat flour | | 0.6% monoglycerides + |
| | (reference | 100% soft | 0.05% L-cysteine + |
| | standard) | wheat flour | 0.5% sunflower oil |
| Raw aspect | 7 | 5 | 6 |
| Texture at T | 7 | 2.5 | 5.5 |
| Texture at 1.5 | 5.5 | 0.5 | 4.5 |
| T (over-cook- | | | |
| ing) | | | |
| Taste | 6 | 4 | 5 |
| Stickiness at 2 | 5 | 0 | 4 |
| T (over-cook- | | | |
| ing) | | | |

Sensory analysis, jury of experts in sensory analysis, for a cooking time T=9 min. The sensory assessment are given as increasing grades from 0 to 7 for the raw aspect, the texture at T and the texture at 1.5 T, and as decreasing grades from 7 to 0 for the stickiness after over-cooking at 2T.

### 2^{nd} Series of Tests and Analyses

In a second time, a series of different homogeneous mixtures have been prepared from soft wheat flour (12.45% humidity, 0.58% ashes in dry matter, 9.90% proteins in dry matter), from 0.5 to 1.5% of water-dispersible monoglycerides and from 0.0% to 0.1% of L-cysteine, so as to evaluate the influence of the content in reducing and amylose-complexing agents.

These mixtures have been hydrated with water until forming corresponding paste-like compositions having a humidity rate of about 32-32.5%, which paste-like compositions have been extruded and shaped by being passed through a mould to form alimentary pastes of the torti type. Then, the so-obtained “fresh” pastes have been subjected to a drying step according to a drying scheme synthetized in the following table.

Drying scheme

| | | Temperature | Relative |
|---|---|---|---|
| Cumulated | | of air | humidity of air |
| duration (min) | Phase | (° C.) | (%) |
| 0 | PRE-DRYING | 80 | 85 |
| 20 | | 80 | 85 |
| 30 | | 80 | 81 |
| 35 | | 80 | 81 |
| 40 | DRYING | 78 | 81 |
| 60 | | 78 | 81 |
| 70 | | 78 | 78 |
| 230 | | 78 | 78 |
| 290 | COOLING | 25 | 58 |

The following table summarizes the results obtained according to the content in reducing and amylose-complexing agents.

| | | Correcting agents | | | Sensory analysis after cooking | | | |
|---|---|---|---|---|---|---|---|---|
| | Flour | % | | Raw | Texture | | Texture | Stickiness after |
| Test | % | Mono- | % | aspect | at T = 9 min | Taste | at 1.5 T | over-cooking at 2 T |
| no | Prot. | glyc. | L-cyst. | Note a | Note b | Note c | Note d | Note e |
| 0 | 9.9 | — | — | 4.0 | 5.0 | 6.0 | 3.0 | 2.0 |
| 1 | 9.9 | 1.5 | 0.1 | 4.0 | 3.0 | 6.0 | 3.0 | 5.0 |
| 2 | 9.9 | 1.5 | 0.065 | 4.0 | 4.0 | 6.0 | 4.0 | 6.0 |
| 3 | 9.9 | 1.5 | 0.03 | 3.5 | 4.0 | 6.0 | 4.0 | 6.0 |
| 4 | 9.9 | 1 | 0.065 | 4.0 | 4.5 | 6.0 | 4.5 | 5.0 |
| 5 | 9.9 | 1 | 0.1 | 4.5 | 4.0 | 6.0 | — | 5.5 |
| 6 | 9.9 | 0.5 | 0.1 | 4.0 | 5.0 | 6.0 | — | 2.5 |
| 7 | 9.9 | 1 | 0.03 | 3.5 | 4.5 | 6.0 | — | 6.0 |
| 8 | 9.9 | 0.5 | 0.03 | 3.5 | 5.5 | 6.0 | — | 5.0 |
| 9 | 9.9 | 0.5 | 0.065 | 5 | 4.5 | 5.0 | — | 3.0 |
| 10 | 9.9 | 0.88 | 0.06 | 4.5 | 5.0 | 6.0 | 5.5 | 4.0 |
| 11 | 9.9 | 0.88 | — | 4.0 | 4.5 | 6.0 | 5.0 | 4.0 |

Sensory analysis by a jury of experts in sensory analysis, for a cooking time T = 9 min. The sensory assessment are given as increasing grades from 0 to 7 for the raw aspect, the texture at T and the texture at 1.5 T, and as decreasing grades from 7 to 0 for the stickiness after over-cooking at 2 T.

### POSSIBILITY OF INDUSTRIAL APPLICATION

The invention finds its industrial application in the making of pasta and in the preparation of mixtures based on wheat flour and paste-like compositions comprising gluten liable to be implemented for making pasta.

1. A mixture intended to be hydrated to form a paste-like composition comprising gluten, for making alimentary pastes, said mixture including a wheat flour substantially exclusively composed of soft wheat flour, characterized in that it includes a reducing agent and an amylose-complexing agent and in that said wheat flour is the single source of gluten of said paste-like composition.

2. The mixture according to claim 1, characterized in that said wheat flour has a protein content in dry matter comprised between about 8 and 11%, preferably lower than 10%, for example equal to 9.9%.

3. The mixture according to claim 2, characterized in that said wheat flour has an ash content comprised between about 0.4 and 0.7%, expressed on dry matter basis, preferably comprised between 0.5 and 0.6%.

4. The mixture according to claim 1, characterized in that said mixture is devoid of any additional enzymatic agent.

5. The mixture according to claim 1, characterized in that it includes from about 0.005 to 1% in weight of reducing agent, and from about 0.5 to 1% in weight of amylose-complexing agent.

6. The mixture according to claim 1, characterized in that the reducing agent is a sulfhydryl-containing reducing agent chosen among the group formed by the sulphur dioxide, the sodium metabisulphite, the L-cysteine and its hydrochlorides and sodium and potassium salts, and the glutathione.

7. The mixture according to claim 1, characterized in that the amylose-complexing agent is an emulsifier chosen among the group formed by the fatty acid monoglycerides and diglycerides and the esters of these latter.

8. The mixture according to claim 7, characterized in that said amylose-complexing agent is a water-soluble or at least water-dispersible emulsifier.

9. The mixture according to claim 6, characterized in that said reducing agent is the L-cysteine and the amylose-complexing agent is consisted of water-soluble or at least water-dispersible monoglycerides.

10. The mixture according to claim 9, characterized in that it includes:
from 0.03 to 0.1% in dry matter, and preferably 0.06%. of L-cysteine, and
from 0.5 to 1% in dry matter, and preferably 0.88%, of monoglycerides.

11. A paste-like composition comprising gluten intended to be shaped and dried to form alimentary pastes, characterized in that it comprises a mixture according to claim 1 and water to hydrate said mixture.

12. An alimentary paste prepared by shaping and drying a paste-like composition according to claim 11.

13. A method for making alimentary pastes, comprising a step of preparing a paste-like composition comprising gluten, by hydration of a mixture according to claim 1.

14. The method according to claim 13, characterized in that it comprises a step of vacuuming and compressing said paste-like composition, the vacuum mechanical compression being made under a pressure comprised between about 70 and 110 bars, preferably equal to about 100 bars.

15. The method according to claim 13, characterized in that it comprises a step of shaping said paste-like composition followed with a drying step to form alimentary pastes from said paste-like composition, and in that said drying step comprises a pre-drying phase at the end of which the relative humidity of said pastes is of about 18%, followed with a drying phase at the end of which the relative humidity of said pastes is comprised between about 11 and 13%, preferably between about 12 and 12.5%.

16. The method according to claim 15, characterized in that said drying step being made under hot and humid air,
said pre-drying phase is carried out at a first temperature of air maintained constant and comprised between about 70 and 90°, preferably close to 80° C., and under a first relative humidity rate of air progressively decreased from about 90% to about 80%, preferably from about 85% to about 80%,
said drying phase is carried out under a second temperature of air maintained constant and comprised between about 70 and 90°, while being lower than said first temperature, for example between 70 and 80° C., and under a second relative humidity rate of air progressively decreased from about 80% to about 75%.

17. The method according to claim 15, characterized in that said drying step being made under hot and humid air,
said pre-drying phase is carried out at a first temperature that is progressively increased from 50° C. to 75-80° C., and under a first rate of humidity comprised between about 70 and 80%,
said drying phase is carried out under a second temperature of air maintained constant and comprised between about 75° C. and 90°, preferably higher than 80° C., while being higher than the maximum temperature reached during the pre-drying phase, and under a second relative humidity rate of air comprised between about 70% and 75%.

18. The method according to claim 16, characterized in that said drying step further comprises, at the end of the drying phase, a cooling phase during which the temperature of air is brought back to a temperature close to the ambient temperature, said cooling phase being carried out by abruptly lowering the temperature and the relative humidity of air, the relative humidity of air being decreased less rapidly than the temperature or air.
